(19) United States
(12) Patent Application Publication
(10) Pub. No.: US 2010/0208637 A1
(43) Pub. Date: Aug. 19, 2010

(54) METHOD OF TRANSMITTING/RECEIVING DATA FOR WIRELESS SENSOR NETWORK AND SENSOR NODE

(75) Inventors: Lae-Jeong Park, Gangneung-si (KR); Tae-Yun Chung, Gangneung-si (KR); Yong-Soon Park, Gangneung-si (KR)

Correspondence Address: CANTOR COLBURN, LLP, 20 Church Street, 22nd Floor, Hartford, CT, 06103, US

(73) Assignee: Gagneung-Wonju National University Industrial Academy Cooperation Group, Gangneung--si (KR)

(21) Appl. No.: 12/670,305

(22) PCT Filed: Jun. 23, 2008
(86) PCT No.: PCT/KR08/03552

§ 371 Date: Jan. 22, 2010

(30) Foreign Application Priority Data
Jul. 23, 2007 (KR) 10-2007-0073671

(51) Int. Cl. G08C 17/02

(52) U.S. Cl. 370/311

(57) ABSTRACT

A method of transmitting and receiving data for a wireless sensor network system is disclosed. Transmission and reception intervals for a small amount of data and for a large amount of data are set. A sensor node checks data requested to be transmitted. If the data is a small amount of data, the sensor node transmits the data to a higher or lower communication node during the transmission interval for a small amount of data. If the data is a large amount of data, the sensor node divides the large amount of data and then transmitting resulting data to the higher or lower communication node during the transmission interval for a large amount of data. The sensor node receives the small amount of data during the reception interval for a small amount of data and the large amount of data during the reception interval for a large amount of data.

### TECHNICAL FIELD

The present invention relates, in general, to a wireless sensor network system, and, more particularly, to a method of transmitting and receiving data for a wireless sensor network.

### BACKGROUND ART

With the development of wireless sensor network systems, sensor nodes are provided with various sensing functions. In particular, the functions provided in recent sensor nodes include not only simple functions of sensing temperature, invasion by someone and the occurrence of a fire but also imaging functions selectively provided in order to improve the accuracy of sensed data.

However, in such a wireless sensor network system configured to transmit and receive a small amount of sensed data, the transmission and reception of image data, obtained by the imaging, is a problem which is difficult to solve.

Therefore, in order to solve the above problem, the present applicant submitted an application Korean Unexamined Patent Publication No. 10-2007-0004098 entitled “Data Transmission and Reception Method and Communication System thereof” to the Korean Intellectual Property Office. The technology applied for in the patent discloses a technology of, when a large amount of data, such as image data, is required to be transmitted and received, transmission and reception nodes setting the size and number of packets in advance, dividing the large amount of data into a plurality of packets corresponding to the setting, and then transmitting and receiving the packets.

However, in the wireless sensor network system which adopts a time division communication method, it is difficult to apply the above-described technology.

This will be described in detail with reference to FIG. 1 which shows the communication process of the wireless sensor network system which adopts a time division communication method.

A reception interval, a transmission interval, and a sleeping interval are set for each of sensor nodes. The node receives data from a higher or lower communication node during the reception interval, transmits data to a higher or lower communication node during the transmission interval, and sleeps during the sleeping interval.

In the case in which a third node which is the lowermost sensor node has data to be transmitted to a first node which is the highest sensor node, the third node transmits the data to a second node which is the higher node thereof during the transmission interval thereof. The second node receives the data from the third node during the reception interval thereof, and then transmits it to a first node during the transmission interval thereof. The first node receives the data from the second node during the reception interval thereof.

The first node transmits response data to the second node during the transmission interval thereof in response to the reception of the data. The second node receives the response data from the first node during the reception interval thereof, and then transmits it to the third node during the transmission interval thereof. The third node receives the response data from the second node during the reception interval thereof, receives response data in response to the data transmitted by it, and then terminates the process.

As described above, each of the sensor nodes of the wireless sensor network system which adopts a time division communication method is configured such that, in order to perform efficient operation, transmission and reception intervals are set so that they are appropriate to a small amount of sensed data, and a sleeping interval is set for the remaining time so that the node sleeps.

Therefore, in the case in which the sensor node of a conventional wireless sensor network system, which has transmission and reception intervals set to be comparatively short, transmits and receives a large amount of data, such as image data, using the transmission and reception intervals, there is a problem in that a long period of time is required.

The reason for this is that the transmission and reception of sensed data using other sensing functions are not performed during the time period for which the large amount of data is transmitted and received. Therefore, there is a problem in that, even when real-time notification must be provided, for example, when the occurrence of fires is sensed, the transmission of data about the sense of the occurrence of fires is retarded.

### DISCLOSURE

### Technical Problem

Accordingly, the present invention has been made keeping in mind the above problems occurring in the prior art, and an object of the present invention is to provide a method of transmitting and receiving data for a wireless sensor network system, which separately sets a transmission and reception interval for a small amount of data and a transmission and reception interval for a large amount of data, thereby solving a problem in that the transmission and reception of a small amount of data is retarded due to the transmission and reception of a large amount of data.

### Technical Solution

In order to accomplish the above object, the present invention provides a method of transmitting and receiving data for a wireless sensor network system including setting transmission and reception intervals for a small amount of data and transmission and reception intervals for a large amount of data so that the intervals correspond to a hierarchical structure for a plurality of sensor nodes which constitutes the wireless sensor network system; each of the sensor nodes checking whether data requested to be transmitted is a small amount of data or a large amount of data; if the data requested to be transmitted is a small amount of data, the sensor node transmitting the small amount of data to a higher or lower communication node during the transmission interval for a small amount of data; if the data requested to be transmitted is a large amount of data, the sensor node dividing the large amount of data and then transmitting resulting data to the higher or lower communication node during the transmission interval for a large amount of data; and the sensor node receiving the small amount of data during the reception interval for a small amount of data and the large amount of data during the reception interval for a large amount of data.

### Advantageous Effects

As described above, a transmission and reception interval for a small amount of data and a transmission and reception interval for a large amount of data are separately set, so that the present invention has an advantage of solving the problem of the transmission and reception of a small amount of data being retarded due to the transmission and reception of a large amount of data.

### DESCRIPTION OF DRAWINGS

FIG. 1 is a view showing a data transmission/reception procedure between the sensor nodes of a wireless sensor network system according to a preferred embodiment of the present invention;

FIGS. 2 and 3 are views showing a data transmission/reception procedure between the sensor nodes of the wireless sensor network system according to a preferred embodiment of the present invention;

FIG. 4 is a block diagram showing the configuration of each of the sensor nodes according to a preferred embodiment of the present invention; and

FIGS. 5 to 7 are flowcharts showing methods of transmitting and receiving data between the sensor nodes according to a preferred embodiment of the present invention.

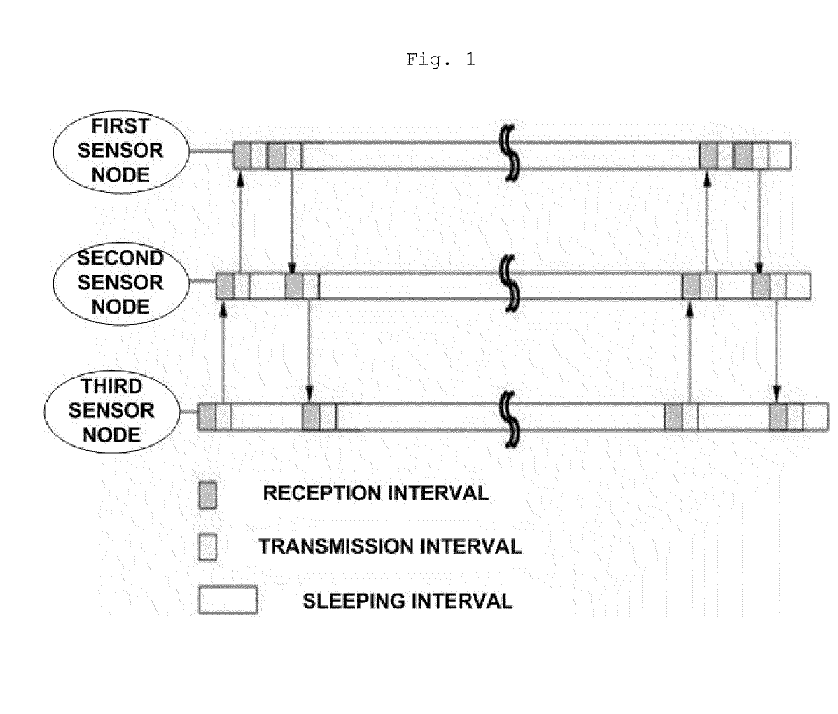

### BEST MODE

A method of transmitting and receiving data for a wireless sensor network system of the present invention includes setting transmission and reception intervals for a small amount of data and transmission and reception intervals for a large amount of data so that the intervals correspond to a hierarchical structure for a plurality of sensor nodes which constitutes the wireless sensor network system; each of the sensor nodes checking whether data requested to be transmitted is a small amount of data or a large amount of data; if the data requested to be transmitted is a small amount of data, the sensor node transmitting the small amount of data to a higher or lower communication node during the transmission interval for a small amount of data; if the data requested to be transmitted is a large amount of data, the sensor node dividing the large amount of data and then transmitting resulting data to the higher or lower communication node during the transmission interval for a large amount of data; and the sensor node receiving the small amount of data during the reception interval for a small amount of data and the large amount of data during the reception interval for a large amount of data.

### MODE FOR INVENTION

The present invention separately sets a transmission and reception interval for a small amount of data and a transmission and reception interval for a large amount of data, thereby solving a problem in that the transmission and reception of a small amount of data is retarded due to the transmission and reception of a large amount of data.

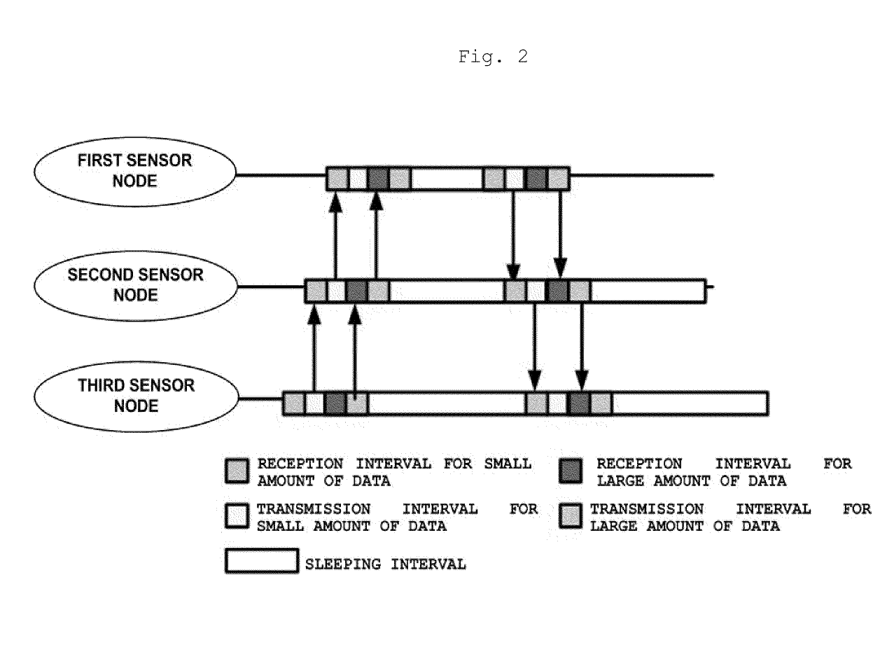

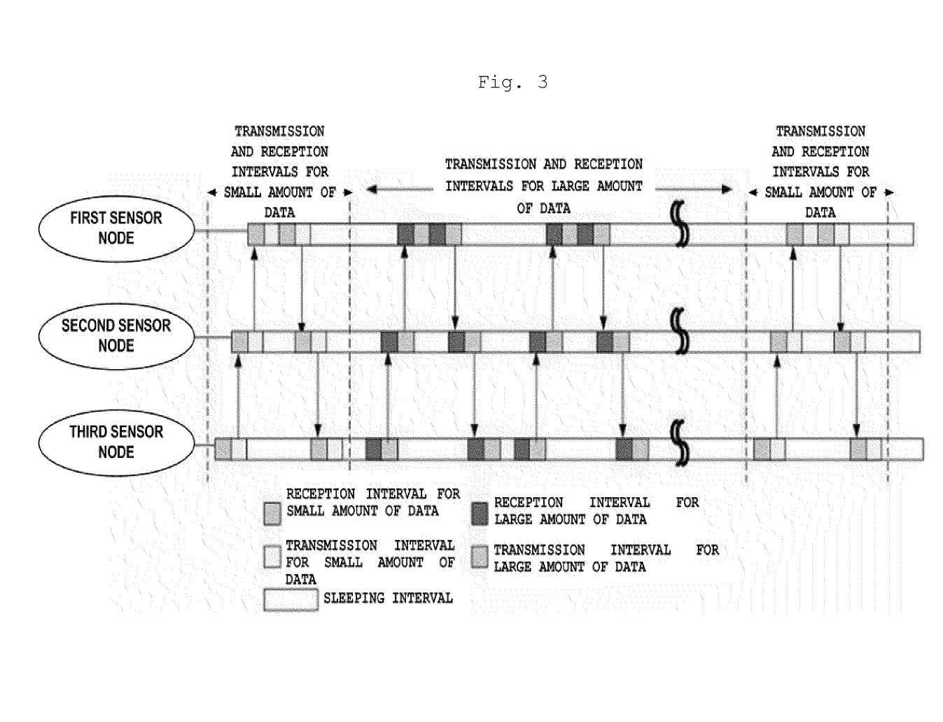

An example of setting transmission and reception intervals according to a preferred embodiment of the present invention will be described in detail with reference to FIGS. 2 and 3.

Transmission and reception intervals for a small amount of data, transmission and reception intervals for a large amount of data, and a sleeping interval are set for each of first to third sensor nodes which constitute a wireless sensor network system. The transmission and reception of a small amount of data are performed during the transmission and reception intervals for a small amount of data, and the transmission and reception of a large amount of data are performed during the transmission and reception intervals for a large amount of data. The transmission and reception intervals for a large amount of data are set for during a sleeping interval from among the communication intervals of a general wireless sensor network system, and the widths of the transmission and reception intervals can be adjusted by the settings of a manager.

The sleeping interval, set for the transmission and reception intervals for a large amount of data, may be a sleeping interval which exists within the transmission interval and reception interval for a small amount of data, as shown in FIG. 2, or may be a sleeping interval which exists between the transmission interval and reception interval for the small amount of data, as shown in FIG. 3.

Each of the first to third sensor nodes checks whether the size of data to be transmitted to the higher node thereof is larger than a predetermined size, that is, the size of a transmission/reception buffer. If the size of data to be transmitted is larger than the predetermined size, division is performed on the data and then resulting data is transmitted through transmission and reception intervals for a large amount of data. If the size of data to be transmitted is not larger than the predetermined size, the data is transmitted through transmission and reception intervals for a small amount of data.

The configuration and operation of the sensor node for transmitting and receiving a small amount of data and a large amount of data will be described according to a preferred embodiment of the present invention.

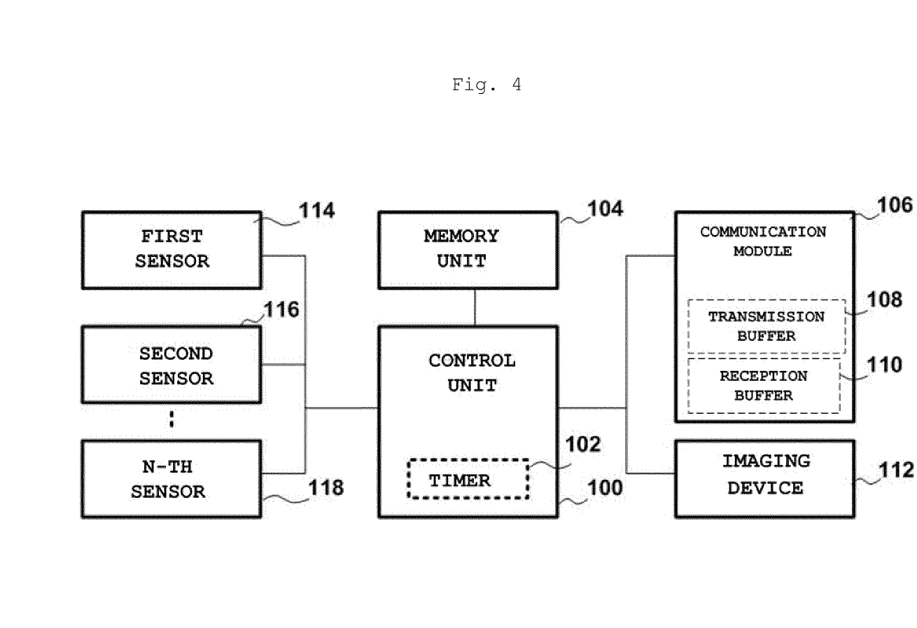

Although some of various sensors are selectively provided as the respective first to third sensor nodes based on the purpose of the sensing, they are similar to each other in configuration other than the fact that the sensors are selectively adopted. Therefore, the configuration and operation of a sensor node will be described with reference to FIG. 4 showing the configuration of any one of the sensor nodes.

The sensor node includes a control unit 100, a memory unit 104, a communication module 106, an imaging device 112, and first to N-th sensors 114 to 118.

The control unit 100 generally controls the sensor node, and performs the transmission and reception of a large amount of data and a small amount of data according to the preferred embodiment of the present invention. The control unit 100 includes a timer unit 102 for counting transmission and reception intervals for a small amount of data, which are respectively used to transmit and receive a small amount of data, and transmission and reception intervals for a large amount of data.

The memory unit 104 stores various information including the processing program of the control unit 100 and, in particular, stores information about the transmission and reception intervals for a small amount of data and the transmission and reception intervals for a large amount of data, and includes buffers for storing a small amount of data and a large amount of data, according to the preferred embodiment of the present invention.

The communication module 106 transmits and receives a small amount of data during the transmission and reception intervals for a small amount of data, and transmits and receives a large amount of data during the transmission and reception intervals for a large amount of data under the control of the control unit 100. The communication module 106 includes a transmission buffer 108 and a reception buffer 110, which correspond to the size of the small amount of data.

The imaging device 112 takes the image of a predetermined opposite location and then provides the image data to the control unit 100 in order to support various sensing operations of the sensor node.

Each of the first to N-th sensors 114 to 118 senses temperature and the occurrence of fires, and then provides the sensed data to the control unit 100.

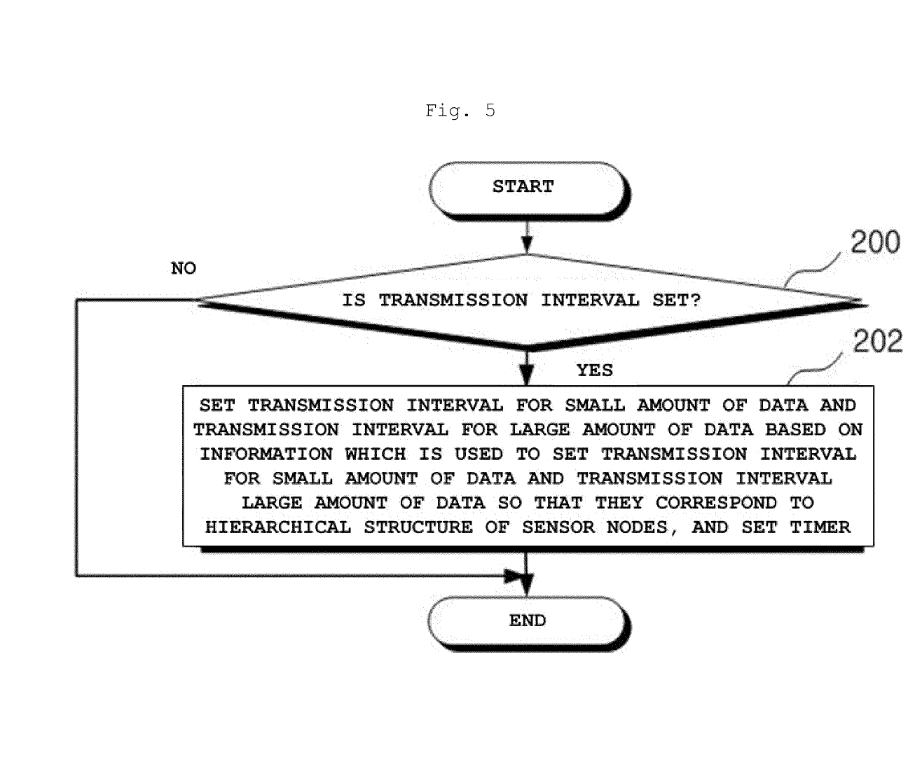

The operation of the sensor node will be described with reference to FIGS. 5 to 7.

FIG. 5 is a flowchart showing a method of setting the data transmission and reception intervals of a communication node for a wireless sensor network system.

The communication node for a wireless sensor network system sets data transmission and reception intervals in response to a request from the highest communication node.

When information, which is used to set transmission and reception intervals for a small amount of data and transmission and reception intervals for a large amount of data, is received from a higher communication node so that the intervals correspond to the hierarchical structure of a plurality of sensor nodes for the wireless sensor network system at step 200, the control unit 100 sets the transmission and reception intervals for a small amount of data and the transmission and reception intervals for a large amount of data based on the information, which is used to set the transmission and reception intervals for a small amount of data and the transmission and reception intervals for a large amount of data, the intervals corresponding to the hierarchical structure of a plurality of communication nodes for the wireless sensor network system, and then the control unit 100 sets the timer 102 such that correspondence is realized for the transmission and reception intervals for the small and large amount of data at step 202.

Here, the transmission and reception intervals for a small amount of data are set to be the data transmission and reception intervals of the communication node for the general wireless sensor network system, and the transmission and reception intervals for a large amount of data are set to be the sleeping intervals of the communication node for the general wireless sensor network system.

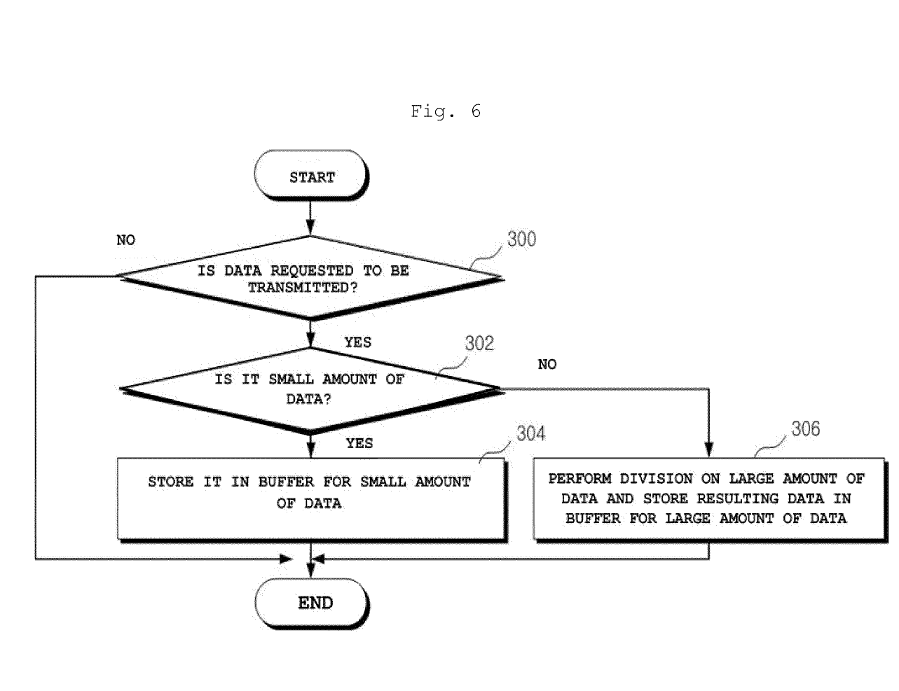

FIG. 6 is a flowchart showing a method of buffering the data of the communication node of the wireless sensor network system.

When data is requested to be transmitted at step 300, the communication node for the wireless sensor network system determines whether the data corresponds to a large amount of data or a small amount of data at step 302. Here, the determination of the data is performed depending on whether the amount of data is larger than the capacity of the transmission buffer 108 of the communication module 106.

If the data requested to be transmitted is a large amount of data, the control unit 100 of the communication node divides the large amount of data so that resulting data corresponds to a transmission interval for the large amount of data, and then sequentially stores the resulting data in a buffer for a large amount of data at step 306.

On the other hand, if the data requested to be transmitted is a small amount of data, the control unit 100 of the communication node stores the small amount of data in a buffer for a small amount of data at step 304.

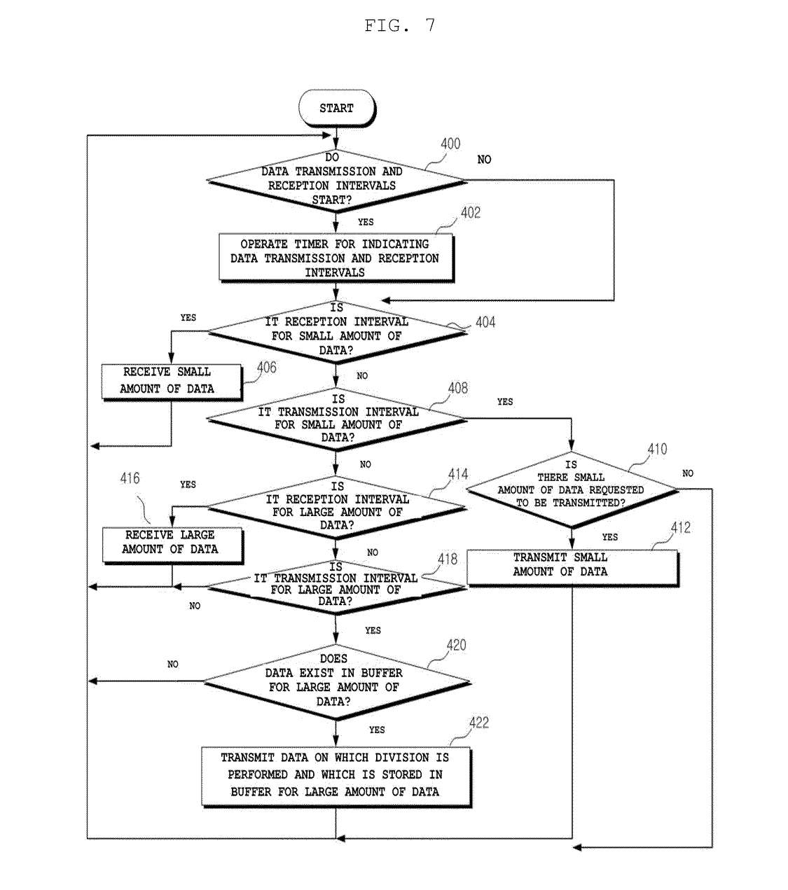

A process of transmitting and receiving data buffered in the buffers, as described above, will be described with reference to FIG. 7.

The control unit 100 of the communication node checks whether a start time for a data transmission and reception interval is reached at step 400.

If the start time for the data transmission and reception interval is reached, the control unit 100 operates the timers of the timer unit 102 for indicating transmission and reception intervals for a small amount of data and transmission and reception intervals for a large amount of data at step 402.

Based on values counted by the timer unit 102, the control unit 100 checks whether the reception interval for a small amount of data starts from the start time of the data transmission and reception interval at step 404.

If the reception interval for a small amount of data starts from the start time of the transmission and reception interval, the control unit 100 receives data from the higher or lower communication node thereof through the communication module 106 at step 406.

Further, based on the values counted by the timer unit 102, the control unit 100 checks whether the transmission interval for a small amount of data starts at step 408.

If the transmission interval for a small amount of data starts from the start time of the data transmission and reception interval, the control unit 100 checks whether there is a small amount of data requested to be transmitted, that is, whether data exists in the buffer for a small amount of data at step 410. If data exists in the buffer for a small amount of data, the control unit 100 transmits data, stored in the buffer for a small amount of data, to the higher or lower communication node thereof through the communication module 106 at step 412.

Further, based on the values counted by the timer unit 102, the control unit 100 checks whether a reception interval for a large amount of data starts from the start time of the data transmission and reception interval at step 414.

If the reception interval for a large amount of data starts from the start time of the data transmission and reception interval, the control unit 100 receives data from the higher or lower communication node thereof through the communication module 106 at step 416.

Further, based on the values counted by the timer unit 102, the control unit 100 checks whether the transmission interval for a large amount of data starts from the start time of the data transmission and reception interval at step 418.

If the transmission interval for a large amount of data starts from the start time of the data transmission and reception interval at step 420, the control unit 100 checks whether data is stored in the buffer for a large amount of data. If data is stored in the buffer for a large amount of data, the control unit 100 transmits the data which is stored in the buffer for a large amount of data and on which division is performed at step 422.

### INDUSTRIAL APPLICABILITY

The present invention is applied to a wireless sensor network system, which separately sets a transmission and reception interval for a small amount of data and a transmission and reception interval for a large amount of data, thereby solving a problem in that the transmission and reception of a small amount of data is retarded due to the transmission and reception of a large amount of data.

1. A method of transmitting and receiving data for a wireless sensor network system, the method comprising:
setting transmission and reception intervals for a small amount of data and transmission and reception intervals for a large amount of data so that the intervals correspond to a hierarchical structure for a plurality of sensor nodes which constitutes the wireless sensor network system;
each of the sensor nodes checking whether data requested to be transmitted is a small amount of data or a large amount of data;
if the data requested to be transmitted is a small amount of data, the sensor node transmitting the small amount of data to a higher or lower communication node during the transmission interval for a small amount of data;
if the data requested to be transmitted is a large amount of data, the sensor node dividing the large amount of data and then transmitting resulting data to the higher or lower communication node during the transmission interval for a large amount of data; and
the sensor node receiving the small amount of data during the reception interval for a small amount of data and the large amount of data during the reception interval for a large amount of data.

2. The method according to claim 1, wherein, if an amount of the data requested to be transmitted is larger than a capacity of a transmission buffer of a communication module, the sensor node determines that the data is the large amount of data.

3. The method according to claim 1, wherein the sensor node has the transmission and reception intervals for a large amount of data which is set such that they are included within a sleeping interval.

4. A sensor node for a wireless sensor network system, comprising:
a communication module for taking charge of communication with a higher or lower communication node; and
a control unit for:
receiving set information corresponding to a hierarchical structure of a plurality of sensor nodes which constitutes the wireless sensor network system, and setting transmission and reception intervals for a small amount of data and transmission and reception intervals for a large amount of data,
checking whether data requested to be transmitted is a small amount of data or a large amount of data,
if the data requested to be transmitted is a small amount of data, transmitting the small amount of data to the higher or lower communication node during the transmission interval for a small amount of data,
if the data requested to be transmitted is a large amount of data, dividing the large amount of data and then sequentially transmitting resulting data to the higher or lower communication node during the transmission interval for a large amount of data, and
receiving the small amount of data during the reception interval for a small amount of data and the large amount of data during the reception interval for a large amount of data from the higher or lower communication node.

5. The sensor node according to claim 3, wherein, if an amount of the data requested to be transmitted is larger than a capacity of a transmission buffer of the communication module, the control unit determines that the data is the large amount of data.

6. The sensor node according to claim 3, wherein the transmission and reception intervals for a large amount of data are set such that they are included within a sleeping interval.
